(19) United States
(12) Patent Application Publication
(10) Pub. No.: US 2018/0030315 A1
(43) Pub. Date: Feb. 1, 2018

(54) RELEASE LINER WITH DIFFERENT SURFACE COATING

(71) Applicant: TESA SE, Norderstedt (DE)

(72) Inventors: Kerstin KLINGEBERG, Hamburg (DE); Ingo NEUBERT, Norderstedt (DE)

(73) Assignee: TESA SE, Norderstedt (DE)

(21) Appl. No.: 15/658,507

(22) Filed: Jul. 25, 2017

(30) Foreign Application Priority Data
Jul. 26, 2016 (DE) 10 2016 213 661.5

(51) Int. Cl. C09J 7/02

(52) U.S. Cl. CPC C09J 7/0253; C09J 2423/101; C09J 2423/041; C09J 2201/606; C09J 2483/005; C09J 133/08

(57) ABSTRACT

A heat-resistant release liner for use on pressure-sensitive adhesives and which comprises
an externally situated silicone release layer (SR);
a layer system (POL) comprising, in each of its layers, based in each case on the total weight of the layer, a total of at least 50% by weight of one or more polyolefins,
where the layer system (POL) comprises, based on the total weight of the layer system (POL), at least 60% by weight of polypropylene; and
an externally situated layer (PER) comprising, based on the total weight of the layer (PER), at least 80% by weight of polyethylene,

where an adhesive bonds the layer (PER) to the next subsequent layer in the structure of the release liner.

This application claims priority of German Patent Application No. 10 2016 213 661.5, filed on Jul. 26, 2016, the entire contents of which is incorporated herein by reference.

The invention relates to the technical field of release liners of the type frequently used for the protection of pressure-sensitive adhesives. More specifically, the invention relates to a release liner which has two different release coatings on its two main surfaces and in which it is therefore possible to realize specific properties on each side.

### BACKGROUND OF THE INVENTION

Adhesive tapes coated on one or both sides with adhesives are mostly wound up at the end of the production process to give a roll in the form of an Archimedean spiral. In the case of double-sided adhesive tapes, the adhesive is covered with a protective covering material (also termed release material) prior to winding of the adhesive tape, in order to prevent contact between the adhesives, or in the case of single-sided adhesive tapes to ensure easier unrolling. The term used by the person skilled in the art for these protective covering materials is release liner or liner. Liners are used not only for the protective covering of single- or double-sided adhesive tapes but also for the covering of labels.

The release liners moreover ensure that the adhesive is not contaminated by dirt before use. It is also possible, by way of the nature and composition of the release materials, to adjust release liners in a manner that permits use of the desired force (small or large) to unroll the adhesive tape. Another function of the release liners in the case of adhesive tapes coated on both sides with adhesive is to ensure that the correct side of the adhesive is uncovered first during unrolling.

A liner or release liner is not a constituent of an adhesive tape or label, but instead is merely an aid to production and storage of these, or for further processing. A liner moreover is unlike an adhesive-tape carrier in that it has no permanent bonding to an adhesive layer.

Release liners used in industry comprise carriers which are made of paper or of film and which are equipped with a release coating (also termed anti-adhesive composition) in order to reduce the tendency of adherent products to adhere to these surfaces (release function). Release coatings used can comprise a wide variety of substances: waxes, fluorinated or partially fluorinated compounds and in particular silicones and various copolymers with silicone content. Silicones have become widely established as release materials in the field of adhesive tape applications in recent years, because of their good processability, low cost and wide range of properties.

There is now also interest in liners with polyolefin release layers.

By way of example, EP 2 354 203 A1 describes an adhesive tape which can be used at temperatures of at least 90° C. and which comprises a pressure-sensitive adhesive layer with a release liner applied thereon. The release liner in turn comprises a base layer comprising a polyolefin resin, and, in contact with the pressure-sensitive adhesive layer, a release layer comprising LDPE.

EP 2 025 507 A1 describes a release agent comprising an ethylene multiblock copolymer, where the ethylene multiblock copolymer is composed of hard-segment blocks comprising at least 95% (w/w) of ethylene and consisting of a comonomer and of soft-segment blocks comprising ethylene and a comonomer; and where the comonomer content in the soft-segment blocks is from 10 to 20 mol % and the content of the hard-segment blocks in the ethylene multiblock copolymer is at most 45% (w/w).

EP 2 298 844 A1 describes an acrylate adhesive tape with a release liner comprising the following: an LDPE surface layer; as second surface layer, a resin mixture comprising LDPE and HDPE as resin components; and an intermediate HDPE layer.

A release liner is generally removed from the adhesive tape immediately prior to application, and in order to facilitate this the liners sometimes have grip aids known as “tabs” on their reverse side (the unrolling side). These facilitate the peeling of the liner in that they remove the requirement for initial penetration between liner and adhesive in order to grip a section of liner and then continue peeling of same; problem-free removal of the liner can be achieved simply by gripping the tab.

To this end, the tabs are welded or adhesive-bonded onto the reverse side of the liner, in a manner such that a grippable portion of the tab has not been bonded to the liner but instead protrudes from the surface thereof or is in contact with the said surface but not bonded thereto. Grip aids of this type are described by way of example in EP 2 426 185 A1.

There is a continuing requirement for release liners with particular properties which are intended to comply with specific usage requirements and specific process-technology requirements.

It is an object of the invention to provide a release liner that is dimensionally stable even at elevated temperatures and that exhibits an adequate release effect in relation to pressure-sensitive adhesives, in particular in relation to polyacrylate-based pressure-sensitive adhesives. It is moreover the intention that it be possible to provide a grip aid to the liner and that it be possible to peel the said liner without difficulty from the adhesive by means of the said aid. The release liner is moreover intended to exhibit an appropriate relationship between strength and flexibility. On the one hand, its strength is intended to inhibit excessive extension or stretching of the adhesive tape during processing and application, but on the other hand the liner is also intended to retain sufficient flexibility for prevention of creasing during application, including application involving curvature, of the adhesive tape with the release liner.

### SUMMARY OF THE INVENTION

Achievement of the object is based on the fundamental concept of the invention: provision of a liner with specific layer structure. The invention firstly, and in normal cases, provides a release liner for use on pressure-sensitive adhesives, comprising
an externally situated silicone release layer (SR);
a layer system (POL) comprising, in each of its layers, based in each case on the total weight of the layer, a total of at least 50% by weight of one or more polyolefins,
where the layer system (POL) comprises, based on the total weight of the layer system (POL), at least 60% by weight of polypropylene; and
an externally situated layer (PER) comprising, based on the total weight of the layer (PER), at least 80% by weight of polyethylene,
where an adhesive bonds the layer (PER) to the next subsequent layer in the structure of the release liner.

### DETAILED DESCRIPTION

Release liners of the invention have proved to have very good heat resistance. It was possible inter alia, immediately after processing, to coat the release layer (SR) of liners of the invention with a pressure-sensitive polyacrylate adhesive processed in the hot-melt process, without any resultant disadvantageous changes in the shape of the release liner. On that side of liners of the invention that is covered by the layer (PER), it was possible to attach one or more grip-aid tabs by a thermal welding process, examples being tabs made of a PET/PE composite or of an aluminium/PET/PE composite. The liner could then be peeled without difficulty from pressure-sensitive adhesives without any resultant impairment of the composite made of grip aid and liner, or of the laminate of the liner.

The meaning of the expression “pressure-sensitive adhesive” in the invention is the generally accepted meaning: a substance which—in particular at room temperature—is durably tacky and adhesive. A pressure-sensitive adhesive has the characteristic feature that it can be applied by pressure to a substrate and continues to adhere thereon; neither the pressure that has to be exerted nor the duration of exposure to the said pressure is defined in any more detail. In some cases, depending on the precise type of pressure-sensitive adhesive, the temperature and the humidity, and also the substrate, a short period of exposure to a minimal pressure not exceeding gentle contact for a brief moment is sufficient to achieve the adhesion effect; in other cases there can also be a need for more prolonged exposure to a high pressure.

Pressure-sensitive adhesives have particular, characteristic viscoelastic properties which provide the durable tack and adhesion. They are characterized in that mechanical deformation results not only in viscous flow processes but also in build-up of elastic recovery forces. There is a particular relationship between the respective components provided by the two processes, this being dependent not only on the precise composition, on the structure and on the degree of crosslinking of the pressure-sensitive adhesive but also on the deformation rate and deformation time, and on the temperature.

The viscous flow component is necessary in order to achieve adhesion. The viscous components deriving from macromolecules with relatively high freedom of motion are solely responsible for good wetting and good flow onto the substrate requiring adhesive bonding. A large viscous flow component leads to high tack (also known as surface tack) and with this often also high adhesive bond strength. Highly crosslinked systems, and crystalline or glassy polymers, exhibit no, or only little, tack because they have insufficient flowable components.

The components providing elastical restoring forces are necessary to achieve cohesion. They derive by way of example from macromolecules that have very long chains and are highly intertwined, and also macromolecules that have been physically or chemically crosslinked, and they permit transmission of the forces acting on an adhesive bond. They allow an adhesive bond to withstand, to a sufficient extent for a prolonged period, a long-term load to which it is exposed, for example taking the form of a long-term shear load.

The magnitude of elastic and viscous component and the ratio of the components to one another can be described and quantified more precisely by using the variables storage modulus (G′) and loss modulus (G″), which can be determined by means of dynamic mechanical analysis (DMA). G′ is a measure of the elastic component, and G″ is a measure of the viscous component of a substance. Both variables depend on deformation frequency and temperature.

The variables can be determined with the aid of a rheometer. The material requiring investigation here is by way of example exposed in a plate-on-plate arrangement to a sinusoidally oscillating shear stress. In the case of shear-stress-controlled equipment, deformation is measured as a function of time, and the time-based offset of this deformation is measured relative to the introduction of the shear stress. This time-based offset is termed phase angle O. Storage modulus G′ is defined as follows: G′=(r/y) ·cos(b) (τ=shear stress, γ=deformation, δ=phase angle=phase shift between shear stress vector and deformation vector). Loss modulus G″ is defined as follows: G″=(τ/γ) ·sin(δ) (τ=shear stress, γ=deformation, δ=phase angle=phase shift between shear stress vector and deformation vector).

A substance is generally regarded as exhibiting tack, and is defined as exhibiting tack for the purposes of the invention, if at room temperature, defined here as 23° C., in the deformation frequency range from 10° to 10¹ rad/sec, G′ is at least to some extent in the range from 10³ to 10⁷ Pa and G″ is likewise at least to some extent in the said range. “To some extent” means that at least a section of the G′ curve is within the window defined by the deformation frequency range from, and including, 10⁰ to, and including, 10¹ rad/sec (abscissa) and by the range of the G′ values from, and including, 10³ to, and including, 10⁷ Pa (ordinate). For G″ this applies correspondingly.

The expression “externally situated layer” means that the relevant layer forms one of the two layers externally delimiting the layer structure of the liner, i.e. that above the said layer there is no further layer belonging to the structure of the liner.

The silicone release layer (SR) (also simply “silicone release layer” hereinafter) can preferably be derived from a crosslinkable silicone system. Among these crosslinkable silicone systems are mixtures of crosslinking catalysts and what are known as heat-curable condensation- or addition-crosslinking polysiloxanes.

The silicone release layer can be derived from solvent-containing and/or solvent-free systems; it can preferably be derived from a solvent-containing system.

The silicone release layer (SR) can preferably be derived from a radiation- (UV- or electron-beam-), condensation- or addition-crosslinking system, particularly preferably from an addition-crosslinking system.

Silicone-based release agents based on addition crosslinking can generally be cured by hydrosilylation. The formulations for the production of these release agents usually comprise the following constituents:
a linear or branched polydiorganosiloxane comprising alkenyl groups,
a polyorganohydrosiloxane crosslinking agent and
a hydrosilylation catalyst.

Platinum and platinum compounds have in particular proved successful as catalysts for addition-crosslinking silicone systems (hydrosilylation catalysts), an example being the Karstedt catalyst (a Pt(0) complex compound).

More specifically, these addition-crosslinking release coatings can comprise the following components:
a) a linear or branched dimethylpolysiloxane which consists of about 80 to 200 dimethylpolysiloxane units and has terminal vinyldimethylsiloxy units at the chain ends. Typical examples are solvent-free, addition-crosslinking silicone oils having terminal vinyl groups, e.g. Dehesive® 921 or 610, both obtainable commercially from Wacker-Chemie GmbH;
b) a linear or branched crosslinking agent which either has only methylhydrosiloxy units in the chain (homopolymer crosslinking agent) or is composed of methylhydrosiloxy units and dimethylsiloxy units (copolymer crosslinking agent), where the chain ends are saturated either by trimethylsiloxy groups or by dimethylhydrosiloxy groups. Typical examples of this product class are hydropolysiloxanes with high content of reactive SiH, for example the crosslinking agents V24, V90 and V06, which are obtainable commercially from Wacker-Chemie GmbH;
c) an MQ silicone resin which also has, as M unit alongside the trimethylsiloxy units usually used, vinyldimethylsiloxy units. Typical examples of this group are the release-force regulators CRA® 17 and CRA® 42, obtainable commercially from Wacker-Chemie GmbH;
d) a silicone-soluble platinum catalyst, for example a platinum-divinyltetramethyldisiloxane complex which is usually termed Karstedt complex and which is obtainable commercially by way of example as catalyst OL from Wacker-Chemie GmbH.

Silicone-containing systems for the production of release coatings can be obtained commercially by way of example from Dow Corning, Wacker or Rohm&Haas.

Mention may be made by way of example of “Dehesive® 914”, which comprises a vinylpolydimethylsiloxane, the crosslinking agent “Crosslinker V24”, a methylhydropolysiloxane, and the catalyst “Catalyst OI”, a platinum catalyst in polydimethylsiloxane. This system is obtainable from Wacker-Chemie GmbH. It is moreover possible by way of example to use the addition-crosslinking silicone release system “Dehesive® 940A” from Wacker-Chemie with an associated catalyst system.

The silicone release system is usually applied in the uncrosslinked condition and crosslinked subsequently.

Among the silicones mentioned, the addition-crosslinking silicones have the greatest commercial importance. However, an undesired property of these systems is their sensitivity to catalyst poisons, for example heavy metal compounds, sulphur compounds and nitrogen compounds (cf. in this connection “Chemische Technik, Prozesse and Produkte” [Chemical technology, processes and products] by R. Dittmeyer et al., Volume 5, 5^{th} Edn., Wiley-VCH, Weinheim, Germany, 2005, Chapter 6-5.3.2, p. 1142). A general rule is that electron donors can be regarded as platinum poisons (A. Colas, Silicone Chemistry Overview, Technical Paper, Dow Corning). Accordingly, phosphorus compounds such as phosphines and phosphites must also be regarded as platinum poisons. The effect of the presence of catalyst poisons is that the crosslinking reaction between the various constituents of a silicone release agent ceases or proceeds only to a small extent. The presence of catalyst poisons, in particular of platinum poisons, is therefore generally strictly avoided during the production of antiadhesive silicone coatings.

Particular embodiments of the silicone systems are polysiloxane block copolymers, for example those having a urea block and marketed by Wacker with the trade name “Geniomer”, or release systems made of fluorosilicones, which are in particular used for adhesive tapes with silicone adhesives.

It is moreover also possible to use photoactive catalysts, known as photoinitiators, in combination with UV-curable cationically crosslinking siloxanes based on epoxy and/or on vinyl ether, or with UV-curable siloxanes amenable to free-radical crosslinking, examples being acrylate-modified siloxanes. Electron-beam-curable silicone acrylates can likewise be used.

Photopolymerizable organopolysiloxane compositions can also be used. Mention may be made by way of example of compositions which are crosslinked by the reaction, in the presence of a photosensitizer, between organopolysiloxanes which have hydrocarbon moieties which have substitution by (meth)acrylate groups and which have direct bonding to silicon atoms (see, for example, EP 0 168 713 B1 or DE 38 20 294 C1). It is likewise possible to use compositions where the crosslinking reaction takes place in the presence of a photosensitizer between organopolysiloxanes having hydrocarbon moieties which have substitution by mercapto groups and which have direct bonding to silicon atoms and organopolysiloxanes having vinyl groups directly bonded to silicon atoms. These compositions are described by way of example in U.S. Pat. No. 4,725,630.

When organopolysiloxane compositions described by way of example in DE 33 16 166 C1 are used, these having hydrocarbon moieties which have substitution by epoxy groups and which have direct bonding to silicon atoms, the crosslinking reaction is induced via liberation of a catalytic quantity of acid obtained by photodecomposition of added onium-salt catalysts. Other organopolysiloxane compositions curable by a cationic mechanism are materials which by way of example have terminal propenyloxysiloxane groups.

The silicone systems can also comprise further additions appropriate to an intended use, for example stabilizers or flow aids.

In a particular embodiment of the invention, the silicone release layer (SR) is a pressure-sensitive adhesive Hkm comprising

at least one pressure-sensitive silicone adhesive Si-Hkm obtainable from a composition comprising
at least one polysiloxane having a plurality of Si-alkenyl groups
at least one substance having a plurality of Si—H groups
at least one hydrosilylation catalyst, and

at least one silicone resin;

where the adhesive bond strength of the pressure-sensitive adhesive Hkm increases with increasing weight per unit area. It is particularly preferable that the silicone release layer (SR) is a pressure-sensitive adhesive Hkm comprising

at least one pressure-sensitive silicone adhesive Si-Hkm obtainable from a composition comprising
at least one polysiloxane having a plurality of Si-alkenyl groups
at least one substance having a plurality of Si—H groups
at least one hydrosilylation catalyst, and

at least one silicone resin;

where the adhesive bond strength of the pressure-sensitive adhesive Hkm increases with increasing weight per unit area, and the release force of the release liner in relation to any desired pressure-sensitive adhesive in contact with the silicone release layer (SR) is from 2 to 100 cN/cm. In particular here, the release force of the release liner in relation to an adhesive tape which comprises a foamed polyacrylate-based layer, for example in relation to the adhesive tape tesa® ACXP^{plus} 7812, is from 2 to 100 cN/cm. It has been found overall that when the release layer (SR) is a pressure-sensitive adhesive Hkm, very good release forces, in particular release forces that are not too low, are achieved in relation to high-viscosity polyacrylate-based pressure-sensitive adhesives.

The polysiloxane which is part of the pressure-sensitive silicone adhesive Si-Hkm and which has a plurality of Si-alkenyl groups is preferably a polydiorganosiloxane comprising a plurality of Si-vinyl groups, in particular a polydimethylsiloxane comprising a plurality of Si-vinyl groups.

The substance which is part of the pressure-sensitive silicone adhesive Si-Hkm and which has Si-H groups is preferably a linear or branched crosslinking agent composed of methylhydrosiloxy units and of dimethylsiloxy units, where the chain ends are saturated either by trimethylsiloxy groups or by dimethylhydrosiloxy groups.

The hydrosilylation catalyst is preferably a conventional, Pt-based catalyst for the addition reaction of the Si—H groups onto the alkenyl groups. The quantity of the said catalyst preferably present in the pressure-sensitive adhesive Hkm is from 50 ppm to 1000 ppm.

The silicone resin of the pressure-sensitive adhesive Hkm is preferably an MQ silicone resin. The silicone resin preferably comprises Si-bonded alkyl moieties and/or Si-bonded alkenyl moieties, in particular methyl moieties and/or vinyl moieties, particularly preferably methyl moieties on those valences of the silicon atoms that are not indicated to Si—O—Si bridges.

The molar ratio of Si—H groups to the Si-alkenyl groups of the polysiloxane of the pressure-sensitive silicone adhesive Si-Hkm is preferably from 1.3:1 to 7:1.

When the pressure-sensitive adhesive Hkm described is used as release layer (SR) of the linear according to the invention, adhesive bonding strength and, associated therewith, the release behaviour of the release layer can be controlled advantageously by way of the layer thickness of the pressure-sensitive adhesive Hkm applied, and also by way of the content of the silicone resin. Increasing application weight of the pressure-sensitive adhesive Hkm results in an increase of adhesive bonding force and therefore an increase of the separation forces required to remove the release liner from the adhesive covered therewith.

The release liner of the invention comprises a layer system (POL) which comprises, based on the total weight of the layer system (POL), at least 60% by weight of polypropylene. The expression “layer system” means a single- or multilayer portion of the layer structure of the release liner of the invention, where in the case of a multilayer layer system, the layers of the said layer system follow one another directly. The layer system (POL) comprises, in each of its layers, a total of at least 50% by weight of one or more polyolefins. The expression “comprising, in each of its layers” also applies, in accordance with what has been said above, to a single-layer layer system, and in this case means “comprising in the layer”.

The layer system (POL) preferably comprises a layer (PPK) comprising, based in each case on the total weight of the layer, at least 60% by weight, more preferably at least 65% by weight, in particular at least 70% by weight, for example at least 75% by weight, of polypropylene. It has been found that these polypropylene contents have an advantageous effect on the heat resistance of the layer (PPK), of the entire layer system (POL) and of the release liner of the invention. The layer (PPK) particularly preferably consists of polypropylene, which is mixed with at most 15% by weight, more preferably at most 12% by weight, of rubber, and with at most 15% by weight, more preferably at most 10% by weight, of colorants.

The layer (PPK) is preferably a polypropylene film. The polypropylene film can have been coloured by using pigments or organic dye, these having been added in the form of a colour masterbatch. The polypropylene film preferably comprises, as already described above, at most 15% by weight, more preferably at most 12% by weight, based in each case on the total weight of the polypropylene film, of rubber. In particular, the polypropylene film consists of a heterophasic polypropylene copolymer with at most 15% by weight rubber content and with at most 15% by weight colorant content, more preferably with at most 12% by weight rubber content and at most 10% by weight colorant content. The rubber is preferably an EPM rubber.

It is particularly preferable that the layer (PPK) is a polypropylene film with melting point at least 160° C. The polypropylene of the layer (PPK) is preferably what is known as a heterophasic PP copolymer (HECO PP, impact PP). A copolymer of this type in particular has high thermal stability. The thermal stability, derived from the melting point, is comparable with that of unmodified homo-PP. However, a heterophasic PP copolymer features better flexibility, and also lower strength and lower brittleness. This is achieved via copolymerization of homo-PP with EP rubber.

In one embodiment of the release liner of the invention, the layer system (POL) comprises a layer (PPK) and a polyolefin layer (POK) comprising at least 25% by weight, more preferably at least 30% by weight, in particular at least 35% by weight, of polyethylene, and also at least 20% by weight, more preferably at least 30% by weight, in particular at least 50% by weight, of polypropylene, based in each case on the total weight of the polyolefin layer (POK). It is very particularly preferable that the polyolefin layer (POK) comprises at least 70% by weight, more preferably at least 80% by weight, in particular at least 90% by weight, based in each case on the total weight of the polyolefin layer (POK), of a mixture of polyethylene and polypropylene in a PP/PE ratio by weight of from 40/60 to 80/20, in particular from 50/50 to 70/30, by way of example from 55/45 to 65/35. It is particularly preferable that the polyolefin layer (POK) consists of this mixture of polypropylene and polyethylene.

In the present text the expressions “polyolefin layer (POK)” and “layer (POK)” denote the same layer.

It is particularly preferable that the polypropylene of the polyolefin layer (POK) is a heterophasic PP copolymer, e.g. an impact polypropylene. The polyethylene of the polyolefin layer (POK) is preferably an mPE, in particular an LLDPE. Fine adjustment of the mechanical properties of a composite made respectively of one or more layers (PPK) and (POK), in particular its strength, can be advantageously achieved by way of the blend ratio. The mechanical properties of the said composite are in particular apparent during coating of the composite with the silicone release composition intended to form the layer (SR) and/or with the composition intended to form the layer (PER). This is particularly advantageously the case in the application of the release liner of the invention, in particular in machine-processing thereof and in use thereof, when an adhesive tape covered therewith is adhesive-bonded around curves. The release liner, or at least the composite described, particularly advantageously has good tensile strength, and is thus resistant to stretching or excessive extension of the adhesive tape during application and processing thereof. It is remarkable that a composite made of the layers (PPK) and (POK) achieves a particularly good balance between the two opposing properties of extensibility and tensile strength.

In one embodiment, the layer system (POL) comprises a layer (PPK), and respectively a layer (POK) arranged on the upper side and underside of, and in direct contact with, the layer (PPK). The two layers (POK) here preferably consist of identical material. It is therefore preferable that the two layers (POK) and the layer (PPK) take the form of a laminate where the layer (PPK) forms a central layer with respectively a layer (POK) arranged on the upper side and underside thereof, where the layers (POK) are respectively in direct contact with the layer (PPK). This three-layer composite particularly preferably takes the form of coextruded film. The composite is in particular produced in the form of blown film, but can also be produced as flat film in the flat-film process.

In another embodiment, the layer system (POL) comprises a layer (POK), and respectively a layer (PPK) arranged on the upper side and underside of, and in direct contact with, the layer (POK). The two layers (PPK) here preferably consist of identical material. Again, this three-layer composite particularly preferably takes the form of coextruded film. The composite is in particular produced in the form of blown film, but can also be produced as flat film in the flat-film process.

In particular, the layer thickness of the respective exterior layers in both embodiments, i.e. in the structure (POK)-(PPK)-(POK) and also in the structure (PPK)-(POK)-(PPK), is identical if production- and/or process-derived variations are ignored. These symmetrical structures are unlike asymmetrical structures in that they exhibit none of the tendency towards curl that is often observed in the latter specifically on exposure to thermal stress.

The raw materials for production of the layers (PPK) and (POK), and therefore in particular the layer (PPK) and, respectively, the layers (PPK) and (POK) preferably comprise less than 1000 ppm by weight of catalyst poisons in respect of the hydrosilylation catalyst of the layer (SR). Otherwise problems can arise in silicone crosslinking, with resultant impairment of release properties of the layer (SR). Materials that are considered to be catalyst poisons are in particular phosphorus- and nitrogen-containing compounds, e.g. phosphite stabilizers such as Irgafos 168 or Irgafos TNPP, and lubricants or antistatic agents having amide functionalities or amine functionalities, e.g. erucamide. It is particularly preferable that the raw materials for the production of the layer (PPK), and, respectively, of the layers (PPK) and (POK), and therefore in particular the layer (PPK) and, respectively, the layers (PPK) and (POK) are free from catalyst poisons in respect of the hydrosilylation catalyst of the layer (SR).

The thickness of the respective central layer in the structure (POK)-(PPK)-(POK) or (PPK)-(POK)-(PPK) is preferably respectively from 40 to 80 μm, more preferably from 50 to 70 μm, in particular from 55 to 65 μm, very particularly preferably from 57 to 63 μm. The thickness of the respective exterior layers in the structure (POK)-(PPK)-(POK) or (PPK)-(POK)-(PPK) is respectively independently preferably from 10 to 30 μm, in particular from 15 to 25 μm, very particularly preferably from 17 to 23 μm. The ratio of the layer thicknesses of the respective central layer and one of the exterior layers in the structure (POK)-(PPK)-(POK) or (PPK)-(POK)-(PPK) is preferably from 10:3 to 10:1.

The liner of the invention moreover comprises at least one externally situated layer (PER) comprising at least 80% by weight of polyethylene. The layer (PER) preferably comprises, based in each case on the total weight of the layer (PER), at least 90% by weight, more preferably at least 95% by weight, in particular at least 98% by weight, for example at least 99% by weight, of polyethylene. It is very particularly preferable that the layer (PER) consists of polyethylene. In particular, the layer (PER) is a polyethylene film. The layer (PER) here can also consist of a blend or mixture of different polymers.

The polyethylene of the layer (PER) is preferably a low-density PE (LDPE). It is particularly preferable that the externally situated layer (PER) consists of LDPE, and in particular the layer (PER) is an LDPE film. In particular, the layer (PER) is an LPDE film with thickness from 10 to 45 μm, very particularly preferably with thickness from 20 to 40 μm, for example from 24 to 33 μm.

The polyethylene film of the layer (PER) is preferably a blown film. The polyethylene film (PER) can also be a multilayer film, e.g. a three-layer film. In the latter case, the film consists of three PE layers.

The density of the LDPE of the layer (PER) is preferably less than 0.925 g/cm³, in particular less than 0.92 g/cm³. A layer (PER) of this type exhibits particularly low release forces or unrolling forces in relation to pressure-sensitive adhesives; it is therefore not necessary to use an additional silicone release coating. The layer (PER) therefore also has particularly high heat resistance. This in turn advantageously provides the possibility of using an efficient heat-sealing process to apply a grip aid to the layer (PER). It is therefore preferable that there is a grip aid applied on at least a portion of the layer (PER).

An adhesive bonds the layer (PER) of the release liner of the invention to the next subsequent layer in the structure of the release liner. It has been found that substantially improved adhesion is thus achieved in comparison to alternative methods for introducing the layer (PER) into the release liner laminate. Examples of alternative methods for introducing the layer (PER) into the release liner laminate are coextrusion of the layer (PER) with the adjacent layer(s) or extrusion coating.

The adhesive can be regarded as lamination adhesive, and is in principle not subject to any restriction in the range of adhesives that can be used, as long as the layer (PER) and the next subsequent layer in the structure of the liner can be bonded therewith in a manner that meets requirements. It is preferable that an adhesive bonds the layer (PER) to a layer (PPK) or (POK). In particular, an adhesive bonds the layer (PER) to one of the respective exterior layers in the structure described above: (POK)-(PPK)-(POK) or (PPK)-(POK)-(PPK) of the layer system (POL).

Adhesive used can in principle be any of the solvent-containing, solvent-free and aqueous adhesives known in the prior art and based on various polymers, e.g. polyurethane, polyester, polyethylene or ethylene-vinyl acetate. It is preferable that the adhesive is a polyurethane-based adhesive. The expression “polyurethane-based” here means that a polyurethane, or the entirety of a plurality of polyurethanes, forms the main constituent of the polymer composition of the said adhesive, i.e. constitutes most of the content of the polymer composition.

Solvent-free polyurethane adhesives can take the form of single- or two-component systems. Other differences can derive from the structure of the polyurethane and from the type of crosslinking. The following polymers are often preferred:
Single-component system: prepolymers with low molecular weight, NCO-terminated, moisture-crosslinking;
Two-component system: prepolymers having terminal NCO groups+polyols.

Aromatic isocyanates are often used, but these are problematic in contact with foods because this can result in formation of primary aromatic amines. Aliphatic isocyanates are therefore sometimes used—in particular when UV-resistance is demanded. Aromatic isocyanates can in principle achieve better adhesion and quicker hardening.

Polyether polyurethanes mostly have greater thermal stability than polyester polyurethanes. However, the polyol component often consists of a mixture of polyester polyols and polyether polyols. Polyols of functionality three and higher are also often used in order to generate additional crosslinking effects; this in turn is often apparent in greater thermal stability.

The adhesive of the embodiment described of the invention is preferably a polyether-polyurethane-based adhesive based on a solvent-free two-component system. It has been found to be advantageous to allow a composite produced by adhesive and made of the layers (PER) and (PPK) or (PER) and (POK) to stand for a number of days in order to achieve full bond strength. It has likewise been found to be advantageous to subject the areas that are to be adhesive-bonded to one another to corona pretreatment before adhesive bonding.

A particular advantage of adhesive bonding of the layer (PPK) or (POK) to the layer (PER) consists in significantly higher bond strength in comparison with coextrusion of the two layers. Coextrusion of the said layers has proved to be possible, but led to lower bond strength values. The bond strength can be improved to some extent by using what are known as adhesion promoters, e.g. maleic-acid-modified polymers, to modify one or both layers, or by using an additional adhesion-promoter layer, known as a tie layer. Despite these measures, bond strength is inadequate for the application, and the layer (PER) is therefore observed to delaminate when a tab is used in an attempt to peel the liner from the adhesive tape.

The invention further provides the use of a release liner of the invention for the protection of pressure-sensitive adhesives. The release liner of the invention is in principle suitable for use on any of the known pressure-sensitive adhesives. The release liner of the invention is preferably used for the covering or protection of pressure-sensitive adhesives comprising poly(meth)acrylate. Particular preference is given to the use of a release liner of the invention as substrate of a coating with the melt of a poly(meth)acrylate-based pressure-sensitive adhesive, where the silicone release layer (SR) is coated. It is very particularly preferable that, after coating with the melt of a poly(meth)acrylate-based pressure-sensitive adhesive, the release liner of the invention is also used for the protection of the said pressure-sensitive adhesive. The expression “poly(meth)acrylate-based pressure-sensitive adhesive” means that the pressure-sensitive adhesive comprises in total at least 30% by weight, preferably at least 50% by weight, in particular at least 60% by weight, of poly(meth)acrylate. The invention likewise comprises combinations and blends of a plurality of main polymers, and also adhesives to which adhesive resins, fillers, ageing retarders, crosslinking agents, etc. have been added.

The pressure-sensitive adhesives intended to be used with the release liner of the invention can of course be used without carrier (“transfer adhesive tape”) or with carrier. Any of the materials known for this purpose can be used as carrier; in particular, it is also possible to use foamed poly(meth)acrylate-based pressure-sensitive adhesives.

### EXAMPLES

Structure of release liner (data in % by weight unless otherwise stated)

Liner 1:

A three-layer blown film (corresponding to “POL”) with the following structure was used as starting material:

20 μm of blend made of 40% of LLDPE (Eltex PF6130, INEOS) and 60% of PP (BA110CF, Borealis) (corresponding to “POK”)

60 μm of 92% of PP (BA110CF, Borealis) and 8% of colour masterbatch (corresponding to “PPK”)

20 μm of blend made of 40% of LLDPE (Eltex PF6130, INEOS) and 60% of PP (BA110CF, Borealis) (corresponding to “POK”).

The abovementioned three-layer film was corona-pretreated on one side. A two-component polyurethane lamination adhesive system (Liofol UR 7780/UR6080, Henkel) was then applied by way of halftone rolls at 40° C. at weight per unit area 2 g/m² onto the pretreated side. A blown film of thickness of 28 μm (corresponding to “PER”) made of LDPE (Purell 1840H, LyondellBasell) was laminated thereto. The adhesive bond was hardened for 10 days at room temperature.

The remaining side of the above three-layer film was coated with an addition-crosslinking silicone system in accordance with the specification below at weight per unit area 1 g/m² (corresponding to “SR”).

Liner 1a:

A three-layer blown film with the following structure was used as starting material: 20 μm of 100% PP (BA110CF, Borealis)

60 μm of blend made of 26% of LLDPE (Eltex PF6130, INEOS) and 66% of PP (BA110CF, Borealis) and 8% of colour masterbatch

20 μm of 100% of PP (BA110CF, Borealis)

The further treatment of the film and the structure of the release liner were as for

Liner 1.

Liner 1 b

The film used and the further steps for the construction of the release liner were as for Liner 1, except that the three-layer film was corona-treated on both sides and likewise provided on both sides with the blown LDPE film of Example 1 by means of lamination adhesive, the materials used here being the same as in Liner 1. The material was then siliconized on one side as for Liner 1.

The procedure was as for Liner 1, except that MP985 (-NCO)/MP730 (-OH), Bostik), a 2-component polyurethane laminating adhesive, wherein MP985 provides the NCO component and MP730 provides the OH-component, was used as lamination adhesive.

Liner 3 (Comparative Example):

A three-layer blown film with the following structure was used as starting material:

20 μm of LDPE (Purell 1840H, LyondellBasell)

80 μm of blend made of 62% of PP (BA110CF, Borealis), 30% of LLDPE (Eltex PF6130, INEOS) and 8% of colour masterbatch)

20 μm LDPE (Purell 1840H, LyondellBasell).

One side of this three-layer film was siliconized as for Liner 1.

Liner 4 (Comparative Example)

The three-layer blown film of Liner 1 was used as starting material.

Immediately after the side intended for coating had been corona-pretreated, this film was coated on one side with an LDPE melt (LD 251, ExxonMobil) heated to 300° C. (extrusion coating). Ozone was also blown onto the hot LDPE melt immediately before coating onto the blown film.

The uncoated side of the film was siliconized as for Liner 1.

Liner 5 (Comparative Example)

A three-layer blown film with the following structure was used as starting material:

20 μm of LDPE (Purell 1840H, LyondellBasell)

80 μm of HDPE (92% of Hostalen GF 9055F, 8% of colour masterbatch)

20 μm of LDPE (Purell 1840H, LyondellBasell).

One side of this three-layer film was siliconized as for Liner 1.

Liner 6 (Comparative Example)

The procedure was as for Liner 1 b. However, no siliconization was carried out.

Liner 7

The procedure was as for Liner 1, except that the blown LDPE film consisted of LD157CW (ExxonMobil, density 0.931 g/cm³).

Production and application of the silicone release layer:

598 g of MQ adhesive resin DC 7066 (Dow Corning), 80 g of Si—H crosslinking agent Syl-Off 7678 (Dow Corning) and 50 g of platinum catalyst Syl-Off 4000 (Dow Corning) were admixed with 1.002 g of the PDMS-based silicone adhesive DC 7651 (Dow Corning). The mixture was diluted with 1179 g of petroleum spirit and homogenized for 30 minutes. The resulting mixture was applied in the form of 1 g/m² layer on the substrate by way of a three-roll applicator using a gravure roll and crosslinked at 120° C. for 30 seconds.

Test Methods
Adhesive-coatability of Liner:
The siliconized side of Liners 1-5 and 7, and also one side of Liner 6, were respectively coated with a foamed polyacrylate-based pressure-sensitive adhesive by the hotmelt process, i.e. the pressure-sensitive adhesive was applied in the molten state at a temperature of from 125 to 135° C.
The pressure-sensitive polyacrylate adhesive was produced as follows:
Production of Main Polyacrylate Polymer:
72.0 kg of 2-ethylhexyl acrylate, 20.0 kg of methyl acrylate, 8.0 kg of acrylic acid and 66.6 kg of acetone/isopropanol (94:6) were charged to a conventional free-radical-polymerization reactor. After passage of nitrogen gas for 45 minutes, with stirring, the reactor was heated to 58° C. and 50 g of AIBN, dissolved in 500 g of acetone, were added. The exterior heating bath was then heated to 75° C., and the reaction was carried out at this constant external temperature. After 1 h, a further 50 g of AIBN, dissolved in 500 g of acetone, were added, and after 4 h the mixture was diluted with 10 kg of acetone/isopropanol mixture (94:6).

After 5 h, and also after 7 h, 150 g of bis(4-tent-butylcyclohexyl) peroxydicarbonate, dissolved in 500 g of acetone, were respectively used for post-initiation. After 22 h of reaction time, the polymerization was terminated and the mixture was cooled to room temperature. The product had 55.8% solids content, and was dried. The K value of the resultant polyacrylate was 58.9, its average molar mass Mw was 748 000 g/mol, its polydispersity D (Mw/Mn) was 8.9 and its static glass transition temperature Tg was −35.2° C.

The synthetic rubber Kraton D1102 and the hydrocarbon resin Piccolyte A115 in the form of a granulate were charged by way of two solids-metering units to the feed section of a planetary-roll extruder with four mixing zones, and were mixed in the first mixing zone to give a homogeneous composition. The main polyacrylate polymer, preheated in a single-screw extruder, was introduced in the following zone. A molten resin comprising the terpene-phenolic resin Dertophen T105 was then metered into the system. The mixture was transferred to a twin-screw extruder, where a solution comprising a crosslinking agent (Polypox R16 20% in Rheofos RDP) and comprising accelerator (20% Epicure 925 in Rheofos RDP) was admixed. A microballoon paste (50% Expancel 051DU40 in Ethomeen C25) was then added. The melt at a temperature of from 125 to 135° C. was coated by way of a twin-roll calender onto the appropriate side of the respective release liner.

After a storage/ripening time of three weeks at room temperature, the product was a single-layer adhesive tape (hereinafter: test tape) with layer thickness 1000 μm and density 700 kg/m³. The composition was 42% of polyacrylate, 10% of Kraton D1102, 25% of Dertophen T105, 15% of Piccolyte A115, 2% of crosslinking-agent/accelerator solution (crosslinking agent: accelerator=1:1), 6% of microballoon paste (data in % by weight).
Delamination
The liner to be tested is trimmed to a width of 15 mm. A metal stamp of area 15×15 mm is used at 190° C. for 3 seconds at a pressure of 3 bar to weld, onto the material to be tested, a tab made of PET/PE laminate, likewise with width 15 mm; (it is also possible to use an aluminium/PET/PE laminate as alternative).

The resulting composite is cooled and then parted, while freely suspended (T-peel), at a velocity of 300 mm/min. The force required here to separate the bond between tab and liner is recorded. This test is used to obtain two measured values:
a relatively high initial peak corresponding to initial delamination, and
a constant measured value corresponding to the actual delamination force for the two materials. Both measured values are always stated.
Force-extension Behaviour in Accordance with DIN EN ISO 527-1
The liner to be tested is trimmed to width 15 mm and length 25 cm. The liner is clamped into a tensile tester with 50 mm clamping-jaw separation without application of any tensile stress, and then is extended at a velocity of 150 mm/min until it breaks or until the maximal traverse of the tensile tester is reached. The mechanical properties of the liner are recorded here.
Performance Test (Tabbing Test)
Two strips of the test tape provided with the liner are applied with separation of about 1 cm longitudinally in succession onto the desired substrate. A tab is applied as grip aid to the near-end region of the first liner. The two liners are also bonded by a bridge made of a tab, in that one end of the tab is welded to the end region of the first liner and the other end of the tab is welded to the near-end region of the second liner of the other strip.

A metal stamp is used for welding at 190° C. and at a pressure of 3 bar, welding time being 3 seconds. A PET/PE laminate is used as tab and bridge; (an aluminium/PET/PE laminate can also be used as alternative). The grip aid is intended to permit removal of the liner from the test tape in a single step.
Evaluation System:
+: Liner can be 100% removed from the test tape in a single step via tab and bridge, irrespective of the position of tab and bridge on the test tape.
∘: Liner can be 100% removed from the test tape in a single step via tab and bridge if tab and bridge are positioned directly at the extreme edge of the test tape.

−: Liner cannot be removed from the test tape. Break-off of the tab from the liner occurs, or cleavage occurs between the individual layers of the liner.
Ease of Adhesive Bonding Around Curves
Usage test: an adhesive tape with defined width is adhesive-bonded under gentle tension around a defined radius (dependent on the width of the adhesive tape, see Table 1). An applicator was used for the adhesive-bonding procedure.

TABLE 1
Relationship of adhesive tape width to adhesive bonding curve radius

| Adhesive tape width (mm) | Adhesive bonding curve radius (cm) |
|---|---|
| 6 | 15 |
| 9 | 18 |
| 12 | 21 |
| 15 | 24 |

Evaluation:
+ no creasing and no lifting of the liner on the internal side of the radius'
− creasing or lifting of the liner on the internal side of the radius'
Peel Force (Liner Removal Force):

This test serves to determine the force required to peel the liner from an adhesive applied thereon. It relates in essence to the interaction between the silicone release layer and the pressure-sensitive adhesive situated thereon.
Liner peel force was determined with tesa® ACXplus 7812 double-sided adhesive tape, width 2 cm.
Sample Preparation:
A strip, length 30 cm, of the adhesive tape was adhesive-bonded, using the side uncovered during unrolling, to the siliconized side (liners 1-5 and 7) and, respectively, one side (Liner 6) of the liner and subjected to a defined application under a 150 g steel roller, which was rolled ten times across the material. The sample was then cut into strips along the applied adhesive tape strips, and the resultant samples were stored horizontally at room temperature for 1 week before the test.
Test:
The liner on the non-adhesive-bonded side of the adhesive tape situated on the liner to be tested was removed, and the sample was fixed with the uncovered adhesive layer on a PE carrier sheet. The fixing method was such that a short section of the liner to be tested protruded beyond the sheet. The test sheet, with the extended end of the liner to be tested pointing downwards, was then clamped into the lower clamping jaw of a tensile tester (BZ2.5/TN1S, Zwick). The extended end of the liner to be tested was clamped into the upper jaw and peeled at an angle of 180° at a machine velocity of 300 mm/min.
Unrolling Force:
This test determines the force required to unroll an adhesive tape which has been provided with a liner and wound up to give a roll. It relates in essence to the interaction between the non-siliconized side of the liner and the adhesive, these being in contact with one another only in the rolled-up condition, and not in the unrolled condition.
The test adhesive tape used was tesa® ACXplus 7812 double-sided adhesive tape, width 2 cm. The pressure-sensitive polyacrylate adhesive on which this (transfer) adhesive tape is based was applied in the form of melt in accordance with the process described under “adhesive-coatability of liner” to the siliconized side of Liners 1-5 and 7 and, respectively, to one side of Liner 6, and subjected to storage/ripening. The resultant adhesive tapes, provided with the liners to be tested, were wound up to give rolls, which were conditioned for 16 h in the climatic conditions for the test (23° C., 50% rel. humidity). The first three laps of each roll were discarded. An insertion mandrel of appropriate size was used to secure the adhesive tape roll in the lower clamping jaw of a tensile tester provided with an unwind device. The end of the adhesive tape was secured in the upper clamping jaw. The machine was then started. The adhesive tape was unrolled at a take-off velocity of 300 mm/min, and the force was measured here over a distance of 230 mm. The average value from all of the measurement points recorded has been stated as result in relation to adhesive tape width.
Low unrolling forces were in principle desired. A value of 185 cN/cm is regarded as upper limiting value for unrolling force; when unrolling forces are higher, the unrolling procedure is no longer sufficiently practicable.

Results of Tests

TABLE 2
Results

| Test criterion | Test method | Liner 1 | Liner 1a | Liner 1b | Liner 2 |
|---|---|---|---|---|---|
| Coatability | Adhesive- | Problem- | Problem- | Problem- | Problem- |
| | coatabilitiy of | free | free | free | free |
| | liner | | | | |
| Adhesion | | | | | |
| Initial peak | Delamination | 22.0 | 21.7 | 22.3 | 20.7 |
| (N/cm) | | | | | |
| Release force | | 11.2 | 11.5 | 11.1 | 10.9 |
| (N/cm) | | | | | |
| Force at 10% | Force- | 20.1 | 18.9 | 22.5 | 19.3 |
| elongation (md) | elongation | | | | |
| [N/mm²] | behaviour in | | | | |
| | accordance | | | | |
| | with DIN EN | | | | |
| | ISO 527-1 | | | | |
| Breaking force | Force- | >25 | >25 | >25 | >25 |
| (md) [N/mm²] | elongation | | | | |
| | behaviour in | | | | |
| | accordance | | | | |
| | with DIN EN | | | | |
| | ISO 527-1 | | | | |
| Max. elongation | Force- | >1200 | >1200 | >1200 | >1200 |
| (md) [%] | elongation | | | | |
| | behaviour in | | | | |
| | accordance | | | | |
| | with DIN EN | | | | |
| | ISO 527-1 | | | | |
| Ease of use | Performance | + | + | + | + |
| | test (tabbing | | | | |
| | test) | | | | |
| Ease of | | + | + | + | + |
| adhesive | | | | | |
| bonding around | | | | | |
| curves | | | | | |
| Release force | Take-off | 18 | 20 | 15 | 16 |
| (cN/cm) | force | | | | |
| 300 mm/min | | | | | |
| Unrolling force | Unrolling | 110 | 105 | 112 | 109 |
| (cN/cm) | force | | | | |
| 300 mm/min | | | | | |

TABLE 3
Results

| Test criterion | Test methods | Liner 3 | Liner 4 | Liner 5/6 | Liner 7 |
|---|---|---|---|---|---|
| Coatability | Adhesive- | Problem- | Problem- | Inadequate | Problem- |
| | coatability of | free | free | coatability* | free |
| | liner | | | | |
| Adhesion | | | | | |
| Initial peak | Delamination | 8.6 | 5.8 | 17.8 | 22.2 |
| (N/cm) | | | | | |
| Release force | | 3.4 | 2.8 | 10.5 | 10.8 |
| (N/cm) | | | | | |
| Force at 10% | Force- | 16.7 | 22.6 | 17.2 | 20.5 |
| elongation (md) | elongation | | | | |
| [N/mm²] | behaviour in | | | | |
| | accordance | | | | |
| | with DIN EN | | | | |
| | ISO 527-1 | | | | |
| Breaking force | Force- | 36.2 | >25 | >25 | >25 |
| (md) [N/mm²] | elongation | | | | |
| | behaviour in | | | | |
| | accordance | | | | |
| | with DIN EN | | | | |
| | ISO 527-1 | | | | |
| Max. elongation | Force- | 1170 | >1200 | >1200 | >1200 |
| (md) [%] | elongation | | | | |
| | behaviour in | | | | |
| | accordance | | | | |
| | with DIN EN | | | | |
| | ISO 527-1 | | | | |
| Ease of use | Performance | ∘ | − | + | + |
| | test (tabbing | | | | |
| | test) | | | | |
| Ease of | | + | + | + | + |
| adhesive | | | | | |
| bonding around | | | | | |
| curves | | | | | |
| Release force | Take-off | 16 | 17 | − | 18 |
| (cN/cm) | force | | | | |
| 300 mm/min | | | | | |
| Unrolling force | Unrolling | 102 | 130 | − | 180 |
| (cN/cm) | force | | | | |
| 300 mm/min | | | | | |

*Liner 5: Creasing during coating process, heat resistance of film inadequate
Liner 6: Melting of LDPE layer during coating with consequent sealing of LDPE layer to adhesive

1. Release liner for use on pressure-sensitive adhesives, comprising
an externally situated silicone release layer (SR);
a layer system (POL) comprising, in each of its layers, based in each case on the total weight of the layer, a total of at least 50% by weight of one or more polyolefins,
where the layer system (POL) comprises, based on the total weight of the layer system (POL), at least 60% by weight of polypropylene; and
an externally situated layer (PER) comprising, based on the total weight of the layer (PER), at least 80% by weight of polyethylene,
where an adhesive bonds the layer (PER) to the next subsequent layer in the structure of the release liner.

2. Release liner according to claim 1, wherein
the polyethylene of the layer (PER) is a low-density polyethylene (LDPE).

3. Release liner according to claim 2, wherein the density of the low-density polyethylene (LDPE) is less than 0.925 g/m³.

4. Release liner according to claim 1, wherein
the layer (PER) consists of an LDPE film with thickness from 10 to 45 μm.

5. Release liner according to claim 1, wherein
the layer system (POL) comprises a layer (PPK) comprising at least 80% by weight of polypropylene.

6. Release liner according to claim 5, wherein
the layer system (POL) comprises a polyolefin layer (POK) comprising at least 25% by weight of polyethylene and at least 20% by weight of polypropylene, based in each case on the total weight of the polyolefin layer (POK).

7. Release liner according to claim 6, wherein
the layer system (POL) comprises a layer (PPK), and respectively a layer (POK) arranged on the upper side and underside of, and in direct contact with, the layer (PPK).

8. Release liner according to claim 6, wherein
the layer system (POL) comprises a polyolefin layer (POK), and respectively a layer (PPK) arranged on the upper side and underside of, and in direct contact with, the polyolefin layer (POK).

9. Release liner according to claim 1, wherein
applied on at least a portion of the layer (PER) there is a grip aid.

10. Release liner according to claim 1, wherein
the silicone release layer (SR) is a pressure-sensitive adhesive Hkm comprising
at least one pressure-sensitive silicone adhesive Si-Hkm obtained from a composition comprising
at least one polysiloxane having a plurality of Si-alkenyl groups
at least one substance having a plurality of Si—H groups
at least one hydrosilylation catalyst, and
at least one silicone resin;
where the adhesive bond strength of the pressure-sensitive adhesive Hkm increases with increasing weight per unit area.

11. A substrate of a coating comprising the release liner of claim 1, with the melt of a poly(meth)acrylate-based pressure-sensitive adhesive, where the silicone release layer (SR) is coated.
